(19) United States
(12) Patent Application Publication
(10) Pub. No.: US 2004/0031649 A1
(43) Pub. Date: Feb. 19, 2004

(54) Industrial truck with a control device

(76) Inventors: Hans-Jorg Schiebel, Kusterdingen (DE); Michael Meinhardt, Reutlingen (DE); Ralf Mebert, Nurtingen (DE)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/459,372

(22) Filed: Jun. 11, 2003

(30) Foreign Application Priority Data
Jun. 14, 2002 (DE) 102 26 598.4

(51) Int. Cl. B66F 9/20

(52) U.S. Cl. 187/223; 187/281

(57) ABSTRACT

An industrial truck has load holding means (3) and a control device (6) to control a lifting movement of the load holding means (3). The control device (6) is connected with at least one operating element that can be actuated by an operator for the lifting movement. The control device (6) is connected with a load sensor (5) which generates a signal which is a function of the weight of a load on the load holding means (3). The control device (6) is realized so that an upward movement of the load holding means (3) is prevented if the weight of a load on the load holding means (3) exceeds a set weight limit.

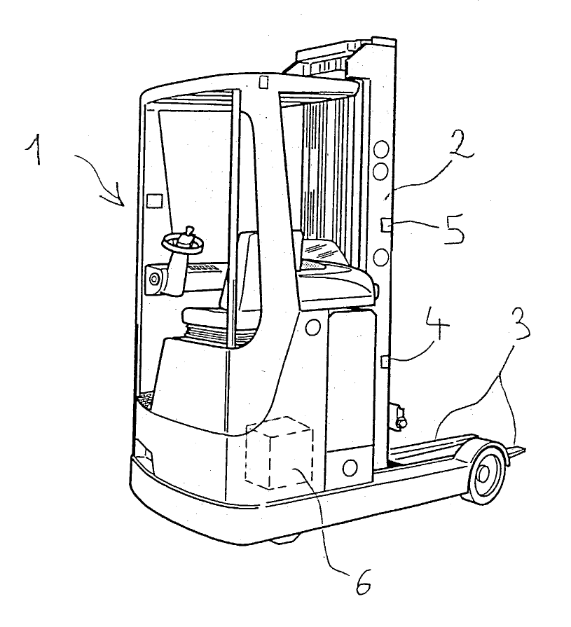

### CROSS-REFERENCE TO RELATED APPLICATION

This application corresponds to German Application No. 102 26 598.4, filed Jun. 14, 2002, which is herein incorporated by reference in its entirety.

### BACKGROUND OF THE INVENTION

1. Field of the Invention

This invention relates to an industrial truck with load holding means and a control device to control a lifting movement of the load holding means, with the control device connected with at least one operating element that can be actuated by an operator for the lifting movement. The invention further relates to an industrial truck with load holding means and a control device to control a traction movement of the industrial truck, with the control device connected with at least one operating element for traction movement that can be actuated by an operator.

2. Technical Considerations

During the operation of a conventional industrial truck, care must be taken that the weight of a load lifted with the load holding means does not exceed the maximum carrying capacity of the industrial truck. Moreover, the allowable lifting height is limited as a function of the weight of the load being raised. This relationship between the weight of the load and the allowable lifting height is generally represented in the form of a load diagram which provides the corresponding information to the operator of the industrial truck. The decision whether and how far a load can be lifted is made by the operator of the industrial truck on the basis of his own knowledge and experience. One object of the present invention is, therefore, to provide an industrial truck in which the function of the lifting device automatically influences the height to which the load can be lifted as a function of the weight of the load.

Most models of industrial trucks are not certified for travel with a raised load. This is true in particular for counterweighted fork-lift trucks or for reach trucks. When the load is raised, the only movements that can be executed are positioning maneuvers at a slow speed. The driver of the industrial truck is responsible for ensuring that the industrial truck travels at a higher speed only when the load has been lowered near to the ground. An additional object of the invention is, therefore, to provide an industrial truck in which the speed of travel is automatically limited to the allowable speed when the load is raised far off the ground.

### SUMMARY OF THE INVENTION

To accomplish the first-named object, the invention teaches that the control device can be connected with a load sensor which generates a signal that is a function of the weight of a load located on the load holding means. The control device can be realized so that an upward movement (elevation) of the load holding means is prevented if the weight of the load on the load holding means exceeds a selected or predetermined weight limit. If the operator orders a lifting of the load by means of the operating element, the control device checks the weight of the load on the load holding means and prevents the lifting of the load holding means if the weight of the load exceeds the weight limit, thus overriding the order given with the operating element.

In this aspect, a first weight limit can correspond to a maximum carrying capacity of the industrial truck, such as that set by the manufacturer. This first weight limit can be permanently defined in the control device. If an attempt is made to lift a weight that exceeds the first weight limit, the control device can immediately terminate the lifting process.

In one aspect of the invention, the control device can be connected with a lifting height sensor that generates a signal which is a function of the lifting height of the load holding means. The control device can be realized so that a second weight limit can be determined continuously as a function of the current lifting height. The second weight limit can thereby be defined in the control device as a function of the current lifting height. For this purpose, the load diagram described above for the industrial truck can be simulated electronically in the control device. If the operator attempts to raise the load holding means beyond the height allowed for the current load weight, the lifting process can be automatically terminated by the control device at the allowable height.

It is particularly advantageous if the lifting height sensor is formed by a measurement transmitter that works at least approximately steplessly. The control device therefore receives a lifting height signal which is stepless, e.g., continuous. Together with the steplessly measured load weight, this signal makes it possible to correctly determine the allowable lifting height at all times. Safety margins of the type that are necessary when conventional load diagrams based on values indicated in tables are used are therefore no longer required.

To accomplish the object regarding the control of the speed of travel of the industrial truck, the invention teaches that the control device can be connected with a lifting height sensor that generates a signal which is a function of the lifting height of the load holding means. The control device can be realized so that the maximum speed of travel of the industrial truck is restricted to a reduced value when the lifting height of the load holding means exceeds a selected or predetermined height limit. In this case, the control device automatically ensures that whenever the load holding means are higher than the set height limit, the industrial truck can only be moved at a reduced speed. This restriction automatically complies with the requirement that most models of industrial trucks may travel at a speed higher than a maneuvering speed when the load is lowered.

As the reduced value of the maximum speed of travel (i.e., the reduced or maneuvering speed), a value between 0.5 and 3.0 km/h can be provided. This value defines the maneuvering speed which is permitted when the load is raised.

The height limit can be between 0.1 and 1.3 meters. The height limit defines the lifted height of the load, above which the load holding means are considered raised, and thus a speed reduction to the maneuvering speed is required.

To determine whether the height limit has been exceeded, it is sufficient if the lifting height sensor is formed by a position switch. The position switch can be formed by a simple switch located in the vicinity of the lifting platform.

In another possible embodiment, the lifting height sensor can be formed by a measurement transmitter that works at least approximately steplessly. In this case, to determine whether a height limit has been exceeded, it is possible to use the same measurement transmitter as the one described above for the automatic setting of the allowable load height.

It is particularly advantageous if the industrial truck of the invention is realized in the form of a reach truck. Reach trucks can achieve particularly high lifting heights compared to other industrial trucks. An automation of the load limiting function and the speed limiting function is therefore particularly helpful for the operator, and allows the operator to concentrate exclusively on the stacking tasks to be performed.

### BRIEF DESCRIPTION OF THE DRAWING

Additional advantages and details of the invention are described below, with reference to the exemplary embodiment illustrated in the accompanying schematic FIGURE.

### DESCRIPTION OF THE PREFERRED EMBODIMENT

The FIGURE shows an exemplary industrial truck of the invention in the form of a reach truck. The reach truck has a telescoping lifting platform 2 located in front of a driver's cab 1. Load holding means 3, e.g., in the form of a load fork, can be moved up and down on the lifting platform 2. A reach truck is an industrial truck which can travel only when the load is lowered. That means that when the truck is carrying a load, it can only be operated at a normal speed of travel if the load is raised to no more than a predetermined height limit, e.g., between 0.1 and 1.3 m. On the other hand, if the load is raised higher than this value (predetermined height limit), the truck may only be operated at a maneuvering speed. The maneuvering speed is slower than the normal speed of travel and is used, for example, to orient the reach truck correctly with respect to a shelf, but not to travel long distances.

The invention teaches that in the vicinity of the lifting platform 2 there is a lifting height sensor 4 which is used to determine whether the load holding means 3 are lowered, i.e., are raised no more than a height limit that is in the range of 0.1 and 1.3 m. The signal from the lifting height sensor 4 is evaluated in a control device 6 of the reach truck. The control device 6 controls, among other things, the speed of travel of the reach truck, and when the load holding means 3 are raised, automatically reduces the maximum speed of travel to the maneuvering speed.

To ensure the operational safety of the reach truck at all times, the maximum allowable lifting height is reduced as the weight of the load increases. To relieve the operator of the need to estimate the weight of the load and the lifting height required to obey this requirement, the reach truck of the invention has, in the vicinity of the lifting platform 2, a load sensor 5, the output signal of which is also transmitted to the control device 6. The lifting height sensor 4 for this function can be realized in the form of a measurement transmitter that measures the lifting height at least approximately steplessly. In the control device, the values measured for the weight of the load and the lifting height can be continuously compared with the allowable value-pairs for lifting height and load weight stored in the control device for the specific model of industrial truck. If the operator attempts to exceed the allowable load height for the load currently being carried, the control device 6 automatically intervenes and prevents any further lifting of the load holding means 3. The same thing happens if the operator attempts to lift a load that exceeds the maximum carrying capacity of the reach truck. The system thereby ensures that neither the maximum carrying capacity of the reach truck nor the maximum weight of the load, which decreases as the lifting height increases, can be exceeded.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An industrial truck, comprising:
a load holding means; and
a control device to control a lifting movement of the load holding means,
wherein the control device is connected with at least one operating element that can be actuated for the lifting movement,
wherein the control device is connected with a load sensor which generates a signal which is a function of the weight of a load on the load holding means, and
wherein the control device is configured such that elevation of the load holding means is prevented if the weight of a load that is being carried on the load holding means exceeds at least one predetermined weight limit.

2. The industrial truck as claimed in claim 1, wherein a first weight limit equals a maximum carrying capacity of the industrial truck.

3. The industrial truck as claimed in claim 1, wherein the control device is connected with a lifting height sensor which generates a signal which is a function of a lifting height of the load holding means, and wherein the control device is configured such that a second weight limit is determined continuously as a function of the current lifting height.

4. The industrial truck as claimed in claim 3, wherein the lifting height sensor includes a measurement transmitter that works at least approximately steplessly.

5. An industrial truck, comprising:
load holding means; and
a control device to control a traction movement of the industrial truck,
wherein the control device is connected with at least one operating element which can be actuated for the traction control,
wherein the control device is connected with a lifting height sensor which generates a signal which is a function of a lifting height of the load holding means, and
wherein the control device is configured such that a maximum speed of travel of the industrial truck is limited to a reduced value when the lifting height of the load holding means exceeds a predetermined height limit.

6. The industrial truck as claimed in claim 5, wherein the reduced value of the maximum speed of travel is between 0.5 and 3.0 km/h.

7. The industrial truck as claimed in claim 5, wherein the height limit is between 0.1 and 1.3 meters.

8. The industrial truck as claimed in claim 5, wherein the lifting height sensor includes a position switch.

9. The industrial truck as claimed in claim 5, wherein the lifting height sensor includes a measurement transmitter which works at least approximately steplessly.

10. The industrial truck as claimed in claim 1, wherein the industrial truck is a reach truck.

11. The industrial truck as claimed in claim 2, wherein the control device is connected with a lifting height sensor which generates a signal which is a function of a lifting height of the load holding means, and wherein the control device is configured such that a second weight limit is determined continuously as a function of the current lifting height.

12. The industrial truck as claimed in claim 6, wherein the height limit is between 0.1 and 1.3 meters.

13. The industrial truck as claimed in claim 6, wherein the lifting height sensor includes a position switch.

14. The industrial truck as claimed in claim 7, wherein the lifting height sensor includes a position switch.

15. The industrial truck as claimed in claim 6, wherein the lifting height sensor includes a measurement transmitter which works at least approximately steplessly.

16. The industrial truck as claimed in claim 7, wherein the lifting height sensor includes a measurement transmitter which works at least approximately steplessly.

17. The industrial truck as claimed in claim 8, wherein the lifting height sensor includes a measurement transmitter which works at least approximately steplessly.

18. The industrial truck as claimed in claim 5, wherein the industrial truck is a reach truck.
